(19) United States
(12) Patent Application Publication
(10) Pub. No.: US 2010/0102729 A1
(43) Pub. Date: Apr. 29, 2010

(54) LIGHT EMITTING DIODE ASSEMBLY

(75) Inventors: Wesley Katzir, Los Angeles, CA (US); Omer Katzir, Woodland Hills, CA (US)

Correspondence Address: STEPTOE & JOHNSON LLP, 2121 AVENUE OF THE STARS, SUITE 2800, LOS ANGELES, CA, 90067, US

(73) Assignee: RETHINK ENVIRONMENTAL, Van Nuys, CA (US)

(21) Appl. No.: 12/576,064

(22) Filed: Oct. 8, 2009

Related U.S. Application Data
(60) Provisional application No. 61/195,785, filed on Oct. 10, 2008.

(51) Int. Cl. H01J 13/32; H05B 39/00; H05B 37/02; B23P 6/00

(52) U.S. Cl. 315/113; 315/312; 315/294; 315/152; 315/297; 29/402.01

(57) ABSTRACT

A lighting assembly using light emitting diodes provides low leakage current that does not require an external ballast. The lighting assembly can replace a fluorescent tube light while providing a more comfortable and steady light source, consuming less power and with enhanced longevity. The lighting assembly includes a tube, a light emitting diode panel disposed within the tube, a circuit board disposed within the tube, and insulation disposed between the light emitting diode panel and the circuit board. At least a portion of the tube is translucent. The light emitting diode panel includes light emitting diodes, and the circuit board includes a driving circuit for driving the light emitting diodes.

### CROSS-REFERENCE TO RELATED APPLICATIONS

This application claims the benefit of U.S. Provisional Application No. 61/195,785 filed Oct. 10, 2008 and titled “LED Light Tube,” which application is hereby incorporated by reference herein in its entirety.

### TECHNICAL FIELD

Embodiments disclosed herein relate generally to improved light emitting diode (“LED”) assemblies.

### BACKGROUND

Fluorescent lighting offers cost and energy savings over incandescent lighting, as fluorescent lighting typically lasts longer than incandescent alternatives. Compact fluorescent lighting assemblies are available as plug-in replacements for some incandescent bulbs. However, fluorescent lighting is not without its disadvantages. For example, fluorescent lighting typically contains mercury and can exhibit photostrobic effects, causing headaches in some individuals. Despite these disadvantages, fluorescent lighting assemblies are used in commercial, industrial, and residential applications.

### SUMMARY

Briefly, and in general terms, there is disclosed an LED light with low leakage current that does not require an external ballast. More particularly, there is disclosed an LED tube light that consumes less power, has enhanced longevity, and that can replace a fluorescent tube light while providing a more comfortable and steady light source.

Additionally, there is disclosed a lighting assembly that includes a tube, a light emitting diode panel disposed within the tube, a circuit board disposed within the tube, and insulation disposed between the light emitting diode panel and the circuit board. At least a portion of the tube is translucent. The light emitting diode panel includes light emitting diodes, and the circuit board includes a driving circuit for driving the light emitting diodes. The lighting assembly may include a reflective coating disposed on a portion of the tube.

The lighting assembly may further include a first end cap disposed on a first end of the tube, and a second end cap disposed on a second end of the tube. The first end cap may include two conductors electrically connected to the driving circuit. These two conductors may be used to connect power leads to the driving circuit.

Furthermore, the lighting assembly may include one or more sensors. For example, a thermal sensor may be used to provide thermal control in the lighting assembly. The driving circuit may be configured to reduce the brightness of the light emitting diodes when a temperature measured using the thermal sensor is greater than a predetermined value. The predetermined value may be selected so as to extend the life of the light emitting diodes. Additionally, or alternatively, thermal protection may be provided. For example, the lighting assembly may include a heat sink attached, for example, to the tube, or forming part of the tube. A portion of the tube may include metal. This too increases the efficiency and lifespan of the light emitting diodes.

The lighting assembly also may include a motion sensor. Using the motion sensor, the driver circuit may be configured to transition between an active state and an inactive state. In the inactive state, the driver circuit reduces the brightness of or turns off some or all of the light emitting diodes. For example, the driver circuit may be configured to enter an active state upon detection of motion using the motion sensor, and to enter an inactive state after a predetermined period of time after the last detection of motion by the motion sensor.

The lighting assembly also may include a remote control sensor. Using the remote control sensor, the driver circuit may be configured to perform various functions in response to signals received by the remote control sensor. These functions may include disabling at least one of the light emitting diodes, and/or changing the brightness of at least one of light emitting diodes.

The lighting assembly also may include a photosensor, which may be used by the driver circuit to control the operation of the light emitting diodes. For example, if the photosensor detects bright light, the driver circuit may adjust the output of the light emitting diodes accordingly. In some instances, it may be desirable to dim the light emitting diodes when bright light is detected, thus reducing energy consumption when additional light is not needed. In other instances, it may be desirable to increase the brightness of the light emitting diodes when bright light is detected such that light emitted by the light emitting diodes may be visible despite bright ambient light.

The lighting assembly also may include color temperature control functionality. Using two or more sets of light emitting diodes, with each set primarily emitting light of different color temperatures, the color temperature of the lighting assembly may be controlled by adjusting the relative brightness of each set of light emitting diodes. For example, and not by way of limitation, two sets of light emitting diodes may be used, with the first set emitting light having a color temperature of approximately 3300 Kelvin and the second set emitting light having a color temperature of approximately 5800 Kelvin. Furthermore, the lighting assembly may use a photosensor and vary the color temperature of the lighting assembly in response to signals received from the photosensor.

The light emitting diode panel may be implemented as a single, substantially planar panel, or as a curved or otherwise non-planar panel. Furthermore, multiple panels may be used, including combinations of curved and planar panels. Multiple panels may be used and oriented to emit light primarily in desired directions. Reflectors also may be used to direct light in desired directions.

Lighting assemblies, such as those described herein, may be configured to be received by fluorescent light sockets, thus providing an LED replacement for fluorescent lighting. For example, a lighting assembly may be configured to fit in a conventional socket of size T4, T5, T8, T10, T12, T14, and the like.

Generally, a method for configuring a fluorescent light fixture for use with a replacement lighting assembly using light emitting diodes includes removing a ballast from the fluorescent light fixture, and removing an external driver from the fluorescent light fixture. Additionally, the fluorescent light fixture may be rewired to power the replacement lighting assembly using the light emitting diodes. For example, the fluorescent light fixture may be rewired to power the replacement lighting assembly using light emitting diodes by wiring a positive voltage line to a first pin of the lamp pin base and wiring a negative voltage line to a second pin of the lamp pin base. In some instances, it may be desirable to disconnect power from one of the lamp pin bases.

Other features and advantages will become apparent from the following detailed description, taken in conjunction with the accompanying drawings, which illustrate by way of example, the features of the various embodiments.

### BRIEF DESCRIPTION OF THE DRAWING

The LED technology is illustrated by way of example and not by way of limitation in the figures of the accompanying drawings. In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIGS. 1A-1E depict a light emitting diode (“LED”) lighting assembly.

FIG. 2A depicts a conventional fluorescent tube fixture.

FIGS. 2B and 2C depict a fluorescent tube fixture modified to accept an LED lighting assembly.

FIG. 2D depicts a fluorescent tube fixture modified to accept an LED lighting assembly.

FIG. 3A is a circuit diagram of a driver circuit.

FIG. 3B is a circuit diagram of an LED panel.

FIGS. 4A-4X are cross-sections of a lighting assembly.

FIGS. 5A-5F depict various layouts of multi-color temperature LEDs in LED panels.

### DETAILED DESCRIPTION

The various embodiments described below are provided by way of illustration only and should not be construed to limit the claimed invention. Those skilled in the art will readily recognize various modifications and changes that may be made to the disclosed embodiments without departing from the scope of the claimed invention. By way of non-limiting example, it will be appreciated by those skilled in the art that particular features or characteristics described in reference to one figure or embodiment may be combined as suitable with features or characteristics described in another figure or embodiment. Further, those skilled in the art will recognize that the devices, systems, and methods disclosed herein are not limited to the lighting embodiments herein.

A lighting assembly 100 may be designed to consume approximately 14 watts of electricity, while outputting as much light as a fluorescent light that consumes approximately 32 watts. The number of LEDs, light characteristics of the LEDs, and transparency/translucency of the tube material may all be designed to generate an appropriate light output.

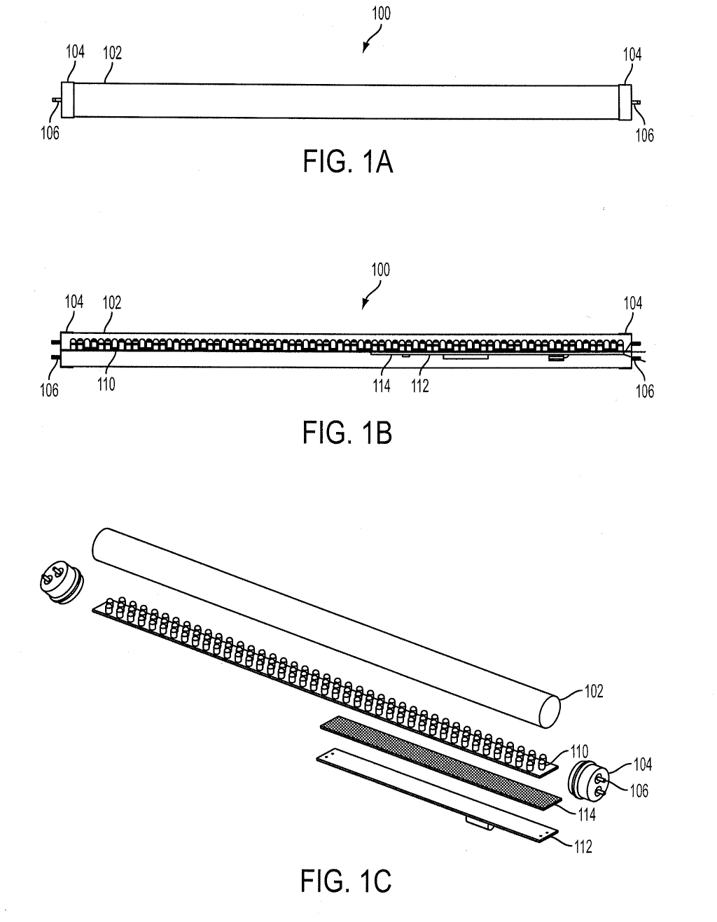

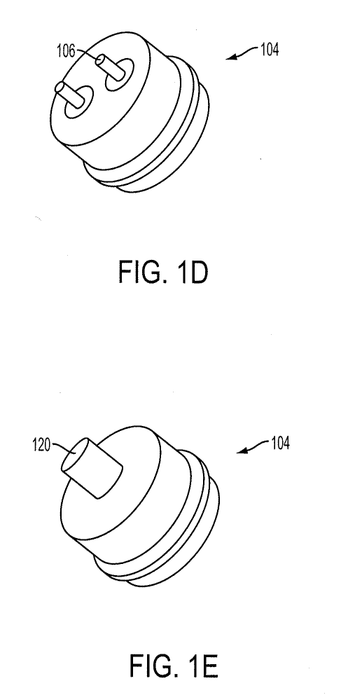

Referring to FIGS. 1A, 1B, and 1C, a lighting assembly 100 includes a tube 102 having two end caps 104 with protruding conductive pins 106. The lighting assembly 100 can replace a fluorescent tube light, such as, but not limited to, a T8 or T12 bulb. The lighting assembly 100 may comprise a panel 110 of LEDs facing at least one direction, and a circuit board 112 including a circuit for driving the LEDs. The circuit for driving the LEDs may be connected to power pins 106 at the end of the tube 102. Preferably, both the positive and negative electrical connections to the LED driver circuit will connect to one end cap 104. The other end cap 104 may be used to secure the light into place, but may not have an electrical connection. One of ordinary skill in the art would recognize that according to some circuit and bulb configurations, both end caps 104 may be electrically connected to the driver circuit.

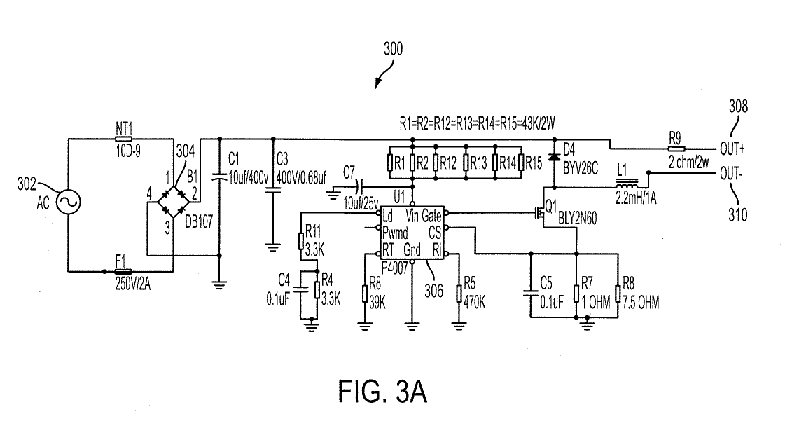

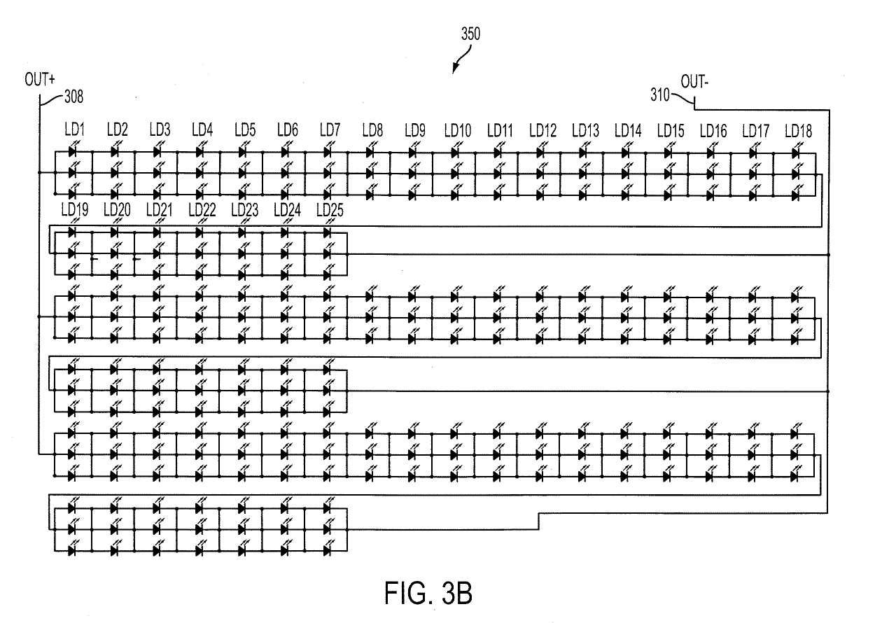

Referring to FIG. 3A, the circuit 300 for driving the LEDs on the circuit board 112 may be implemented using conventional electronic components, including integrated circuits and microcontrollers. An alternative current (“AC”) voltage source 302 supplies power to the circuit 300. This AC source is converted to direct current (“DC”) using a bridge rectifier 304, thus providing a DC supply voltage for driving the LED panel 110. An integrated circuit (“IC”) 306 connects to the DC supply voltage, generating a positive supply 308 and a negative supply 310 to the panel 110.

FIG. 3B is a diagram of a circuit 350 for LED panel 110. The LEDs comprising the panel 110 are connected to the positive supply 308 and the negative supply 310 from the driver circuit 300 so as to power the LEDs. Any number of LEDs may be used, depending on light, output power, and space constraints. Common configurations may include anywhere from 1 to 400 LEDs. A preferred embodiment contains 225 LEDs, resulting in 14 watts of power consumption.

The lighting assembly 100 may be any shape. A common shape is a straight tube, but other shapes include U-shaped and circular tubes. The lighting assembly 100 may also be any size sufficient to hold the LEDs and the driver circuit within the tube 102.

Current leakage is undesirable excess current that, at the very least, wastes energy. However, if there is enough current leakage, it may be dangerous, possibly damaging components, injuring users, and causing fire or explosions. Current leakage also may cause electrical radiation.

The circuit board 112 may be located within the LED light tube 102, behind the LED panel 110. To reduce the possibility of current leakage, the circuit board 112 may be separated from the panel 110 by insulation 114. Connecting both the positive and negative voltage inputs to one end cap 104 of the lighting assembly 100 also helps to eliminate or reduce current leakage. Using both of these techniques (i.e., using one end cap 104 for electrical connection and providing insulation 114 between the circuit board 112 and the LED panel 110) reduces leakage current, which may damage components, create a danger to users, or cause components to operate less efficiently. The driver circuit of the circuit board 112 may comprise electrical components that receive the power from the power leads through the pins 106 of the end cap 104 and convert the power to electricity useable by the LEDs on the LED panel 110 to emit light.

Locating the driver circuit on the circuit board 112 within the LED tube 102 eliminates the need for an external driver or ballast. This results in improved electrical power efficiency. The tube 102 is preferably connectable to the lamp pin bases of standard fluorescent tubes. Preferably, the LED light tube 102 has dimensions that would allow it to be used in a standard fluorescent light fixture without modifying the physical dimensions of the fixture.

The circuit board 112 and LED panel 110 may be fixed within the tube 102 by adhesive, screws, ridges within the tube structure, or any other means suitable to fix the panel 110 and circuit board 112 within the tube. The end caps 104 may also be affixed to the tube 102 via adhesive, screws, welding, or any other suitable means.

There are currently some LED lights on the market, but many use the ballast and starter from the fluorescent fixture. The ballasts typically used in fluorescent lighting fixtures are not necessary for driving LED panels 110, and the use of such components reduces the overall efficiency and energy savings of the lighting apparatus 100. Without the ballast, there is no ballast loss and there is no cost to replace a failed ballast, as with other systems.

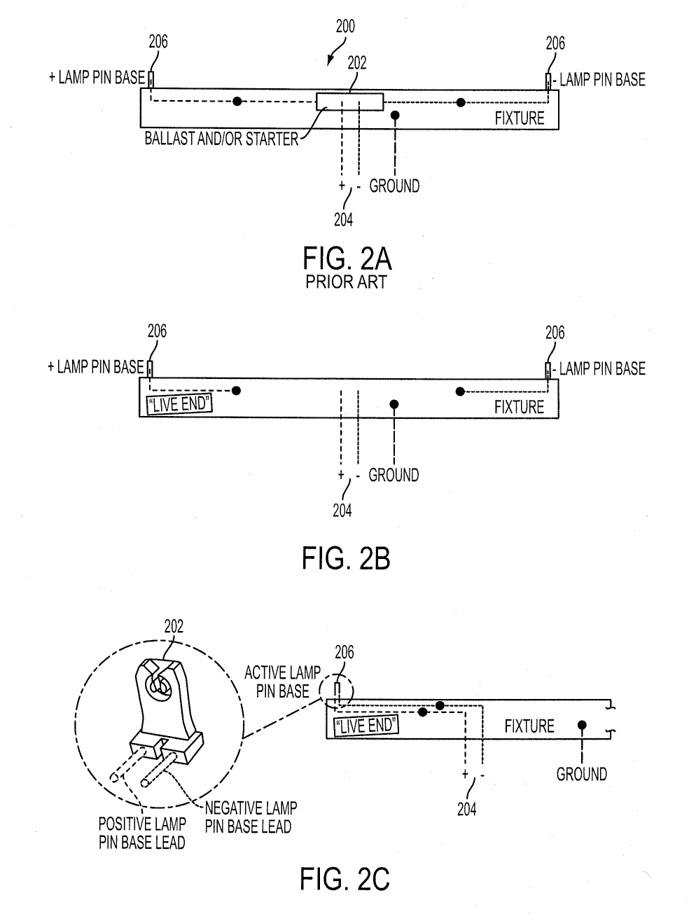

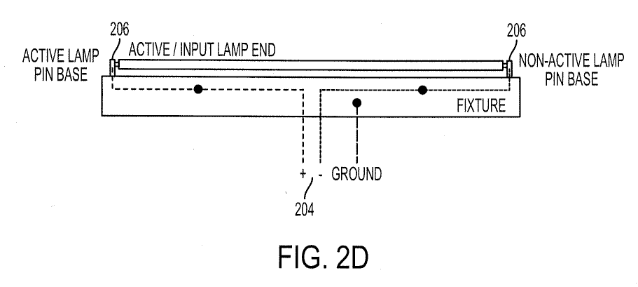

Referring to FIGS. 2A, 2B, and 2C, a fluorescent tube fixture 200 may be electrically modified to receive the lighting assembly 100 by removing the ballast 202 from the fixture, leaving a positive and a negative voltage line 204 intact. The positive voltage line may be connected to one lead of the lamp pin base 206 and the negative voltage line may be connected to the other lead of the lamp pin base 206. Thus, although electrical connections within the fixture 200 may be modified to power the lighting assembly 100, the physical structure of the fluorescent light fixture 200 is unchanged.

Multiple lamp pin bases 206 may be connected to one positive and one negative voltage line 204 by connecting the positive line to one lead of each of the lamp pin bases 206 and the negative line to the other lead of each of the lamp pin bases 206. The lamp pin base 206 at the opposite end of the fixture 200 from the live lamp pin base 206 is preferably electrically disconnected. FIG. 2D depicts an alternative implementation in which the positive and negative leads 204 are connected to different lamp pin bases 206.

The LED light tube 102 may be made of plastic, which decreases any risk of the tube 102 breaking or shattering as in traditional fluorescent light tubes. The tube 102 may also be made of glass, or any other translucent or transparent material that is suitable to pass light from the LED panel 110. Some plastics that may be used include, but are not limited to polyethylene terephthalate, high density polyethylene, polyvinyl chloride, polypropylene, polycarbonate, polystyrene, acrylonitrile butadiene styrene, polyester, polyamides, polyurethanes, polyethylene, cellulose-based plastics, phenolics, and urea-formaldehyde.

Some examples of glass that may be used include, but are not limited to commercial or soda lime glass, lead glass, borocilicate glass, aluminosillicate glass, fuse silica glass, boron glass, safety glass, fiber glass, annealed glass, toughened glass, laminated glass, coated glass, and patterned glass.

The end caps 104 may be made of any of the materials listed above, as well as any other suitable material. The pins 106 on the end caps 104 are preferably copper, but any other conductive material may be used. The non-electrically connected end cap 104 may differ from the electrically-connected end cap 104. The difference may include materials or a label indicating which end is which.

Referring to FIG. 1D, the end cap 104 that is non-electrically connected can be configured with a different arrangement of one or more pins 106 and/or other protrusions or insets so as to prevent or discourage improper installation of the lighting assembly 100. By way of example, and not by way of limitation, FIG. 1E depicts a protrusion 120 that is different from the pin arrangement of the active end cap 104. FIG. 1E may be made of a non-electrically conductive material, and may be designed such that the assembly 100 cannot be installed backwards. The end cap 104 that is non-electrically connected may be made, by way of example and not by way of limitation, of any conductive or non-conductive material identified herein.

The tube 102 may also have a variety of different configurations. For example, in a preferred embodiment, a reflective coating is applied to an outside surface of the tube on a rear surface of the tube (the LED light emission surface being the front surface). The reflective coating may comprise any reflective material, and is preferably a fire retardant metallic paint. The reflective coating decreases light loss due to the prismatic effect of the glass or plastic tube, or when light enters the plastic material of the tube and reflects within the plastic. This enhances the light illumination output so that fewer LEDs can produce the light output associated with a greater number of LEDs. Also, as the quality of LEDs improves, a lighting assembly 100 may require fewer LEDs to produce the same amount of light, thus improving the efficiency of the lighting assembly 100.

A main inhibitor for LED performance is temperature. The hotter an LED is, the worse it performs. In another embodiment, a temperature sensor in the lighting assembly 100 can maintain a temperature within an optimal temperature range. If it's too hot, it will reduce the power output to lower the temperature and increase the longevity and performance of the lighting assembly 100.

Furthermore, thermally conductive materials may be used to dissipate heat. In one embodiment, the tube 102 may be partially comprised of metal, or it may comprise a heat sink. A heat sink may be integral with the tube 102, or attachable to the tube 102. The heat sink is used to reduce the heat of the bulb structure to enhance the output efficiency of the LEDs. In one embodiment, a heat sink comprises a rear part of the tube 102 to which a transparent or translucent front part is attached for emitting light. The heat sink may have any suitable shape. For example, it may extend around the entire tube 102, except for the portions through which light is emitted. The tube may comprise reflectors, which may be integral with the tube 102, insertable into the tube 102, or attachable onto the tube 102. According to one embodiment, the reflectors are located on either side of the LED board, so that light is reflected from the LEDs outward from the tube 102. The tube may comprise any combination of the above features, and may even have a shape that is non-tubular, while still being compatible with fluorescent tube fixtures.

The metal enclosure or heat sink may comprise any suitable metal, including, but not limited to aluminium, extruded aluminium, aluminium alloys, steels such as carbon steel, manganese steel, and galvanized steel, titanium, and tin alloys.

According to one embodiment, a metal enclosure has grooves on an inside surface for securing the LED panel 110 and the circuit board 112. The metal enclosure may extend over half-way around the circumference of the tube 102. The size of the metal enclosure relative to the light-passing portion of the tube can be adjusted based on the purpose of the tube 102. For example, a light for illuminating a smaller area may have metal around a larger portion of the circumference, creating a spotlight effect. The reflectors may also be used to magnify the spotlight effect. Conversely, the tube 102 may have multiple LED panels 110 directed in multiple directions, and the tube 102 may comprise a translucent or transparent material, resulting in an omnidirectional light distribution.

The LED panel 110 may be a flat panel, or it may be curved. Of course, it will be appreciated that the LED panel 110 may be any shape, including triangular, rectangular, circular, or any other shape. A curved LED panel 110 may be used to emit light across a wider area than a flat panel. The curved panel 110 may be a smooth curve, or may be a number of small flat boards connected to each other in such a way that they direct LED light emissions in different directions. According to one embodiment, an LED panel 110 comprises three connected sections-a middle section and two side sections that are connected with the middle section at an angle, so that an LED on the middle section shines light primarily in a first direction, and LEDs on the side sections shine light primarily outward from the middle section.

An LED panel 110 may also be located at the rear of the LED light tube 102. Such a panel 110 would emit light out the rear of the tube, resulting in a more isometric light emission. Based on the above, one of ordinary skill will recognize that LEDs may face any number of directions within the tube 102. If an LED panel 110 is located in the rear of the tube, an opening may be provided in a metal enclosure or heat sink to allow light to pass from the LED panel outside the tube. Reflectors may be used on this portion of the tube for increasing the light output.

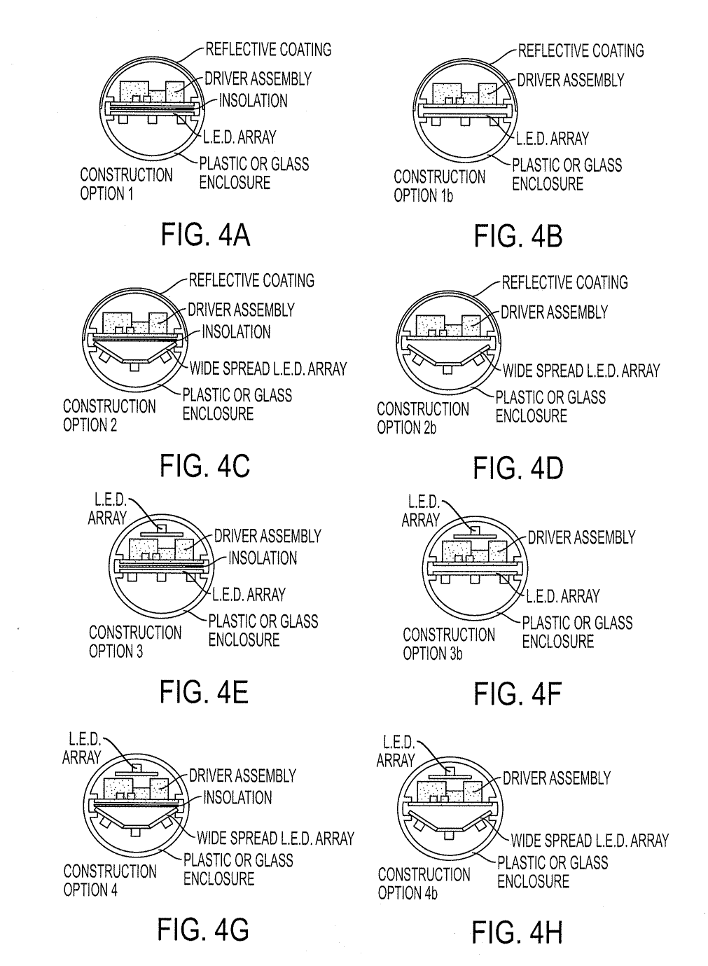

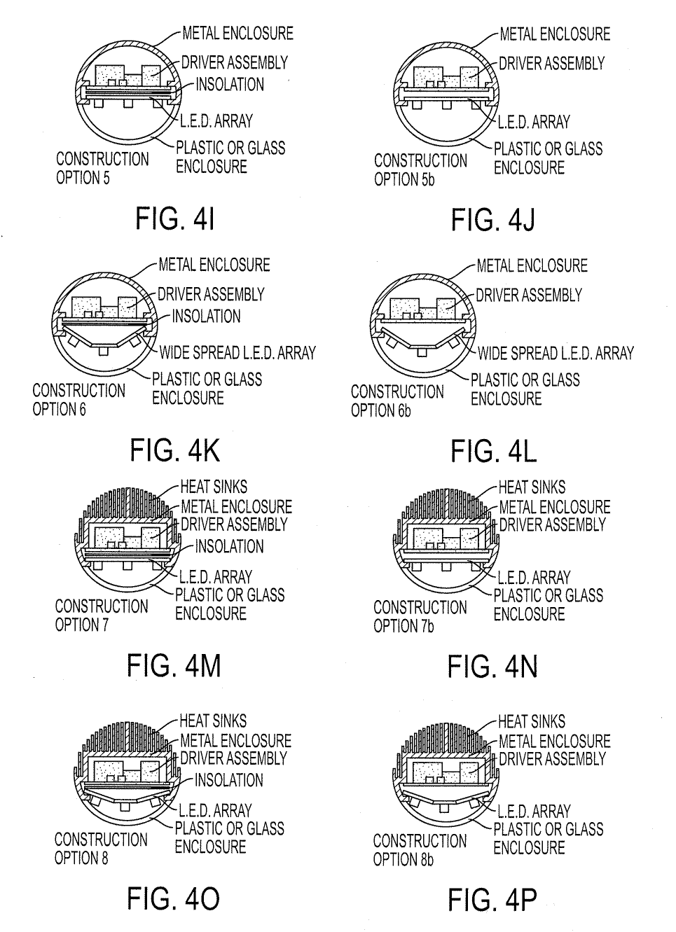

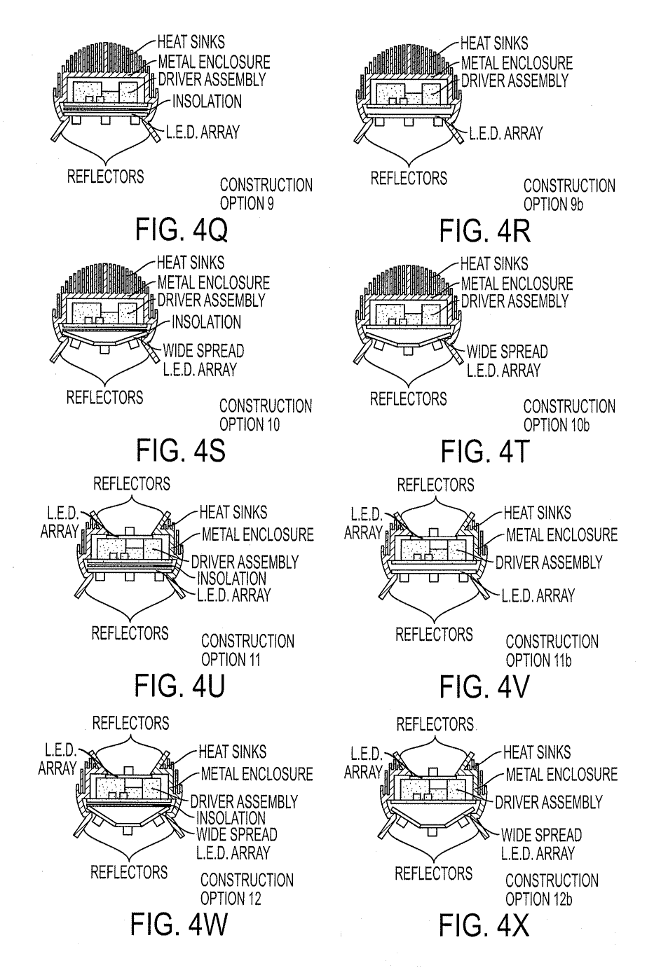

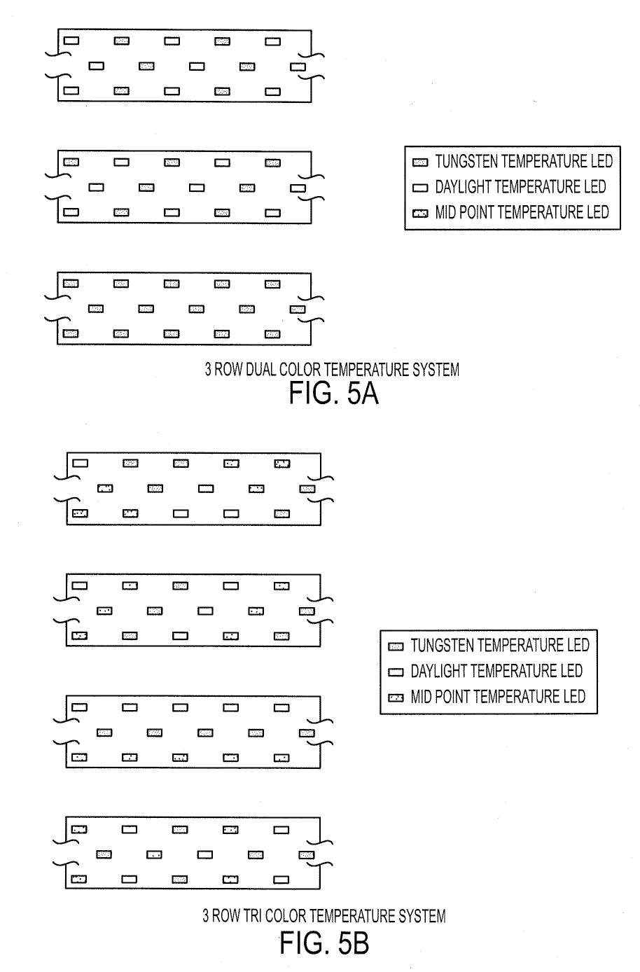

Various cross-sections of lighting assemblies 100 are shown in FIGS. 4A-4X.

One embodiment of the lighting assembly 100 provides LEDs with different color temperatures, resulting in a light quality that is comfortable to users or suitable for the intended use of the LED light tube. For example, and not by way of limitation, one set of LEDs may have a color temperature of 3300K and a second set of LEDs may have a color temperature of 5800K. This results in a bright white light. Other color temperatures and combinations of color temperatures may be used depending on the desired light characteristics.

Both tungsten-based lights and cool white/daylight toned fluorescent bulbs have drawbacks. Fluorescent bulbs have overly green hues, and the light may seem too harsh. Tungsten bulbs often have an overly yellow hue and dim light. By combining the two color temperature ranges within one bulb, the overly green/blue tones and harshness of the fluorescent bulbs and the overly yellow and dim qualities created by tungsten bulbs are eliminated. The combination of LEDs enhances brightness, contrast, glow, clarity, and realistic color rendering. Due to the small size of the LEDs, the two different colors blend to create the most natural and comfortable wash of light without displaying any warm or cool hotspots.

A tri-color temperature system may be used to provide the advantages of a two-color system with added visual blending in the bulb itself. In addition to making the bulb appear more seamless in terms of color variation, the mid-point color also adds slightly increased perceived brightness. Preferably, the mid-point color LED is located physically between the daylight spectrum LED and the tungsten spectrum LED to improve the blending effect.

Examples of LED colors that may be used include, by way of example only: (i) daylight spectrum LEDs (e.g., LEDs having a median color temperature of approximately 5500K within a range between 5000K to 6500K), providing increased brightness and contrast; and (ii) tungsten spectrum LEDs (e.g., LEDs having a median color temperature of approximately 3200K to enhance within a range between 2700K to 3500K), providing enhanced rendering with added visual warmth and viewing comfort. Furthermore, LEDs may be used that exhibit a midpoint color temperature located between the tungsten spectrum color used and the daylight spectrum color used. For example, a midpoint color temperature of 4350K may be used. This temperature is the midpoint between 3200K and 5500K (i.e., (3200K+5500K)/2=4350K).

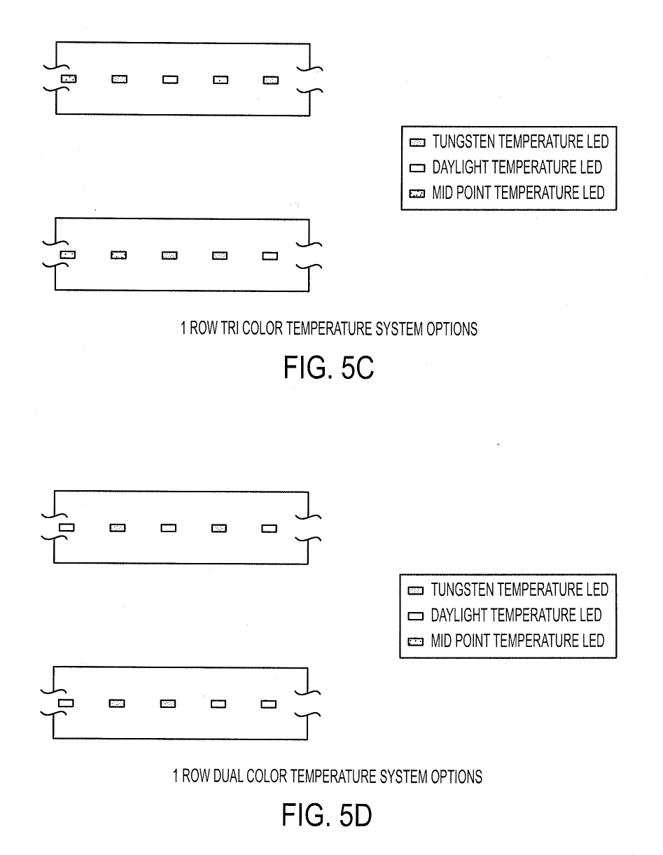

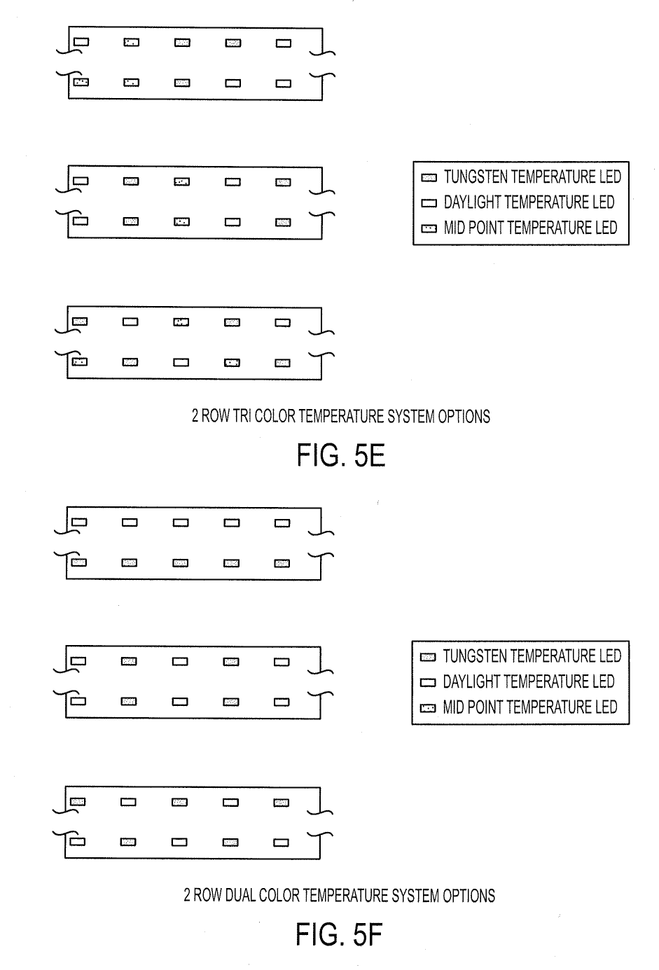

FIGS. 5A-5F depict, by way of example and not by way of limitation, various layouts of LEDs in multi-color LED panels. Although preferred color ranges have been disclosed, one of ordinary skill in the art will recognize that any color ranges may be used, depending on the intended use of the lighting assembly 100. Also, any number of rows of LEDs may be used according to the desired intensity, power consumption, or physical configuration of the lighting assembly 100. For example, the configurations depicted in FIGS. 5A and 5B use three rows of LEDs, the configurations depicted in FIGS. 5C and 5D use one row of LEDs, and the configurations depicted in FIGS. 5E and 5F use two rows of LEDs. The LEDs may be configured in straight rows, staggered rows, or spaced in any other desired configuration on the LED panel 110 to improve light output, color blending, hue, or any other desired characteristic. FIGS. 5A-5F depict various arrangements of LEDs in two-color and three-color configurations, including by way of example and not by way of limitation any of the following or combination thereof: (i) colors alternating across rows; (ii) colors alternating across columns; (iii) colors alternating across diagonals; (iv) colors alternating according to a pattern; and/or (v) random arrangement of colors.

Furthermore, lighting assemblies 100 may include potentiometers that can automatically adjust the color temperature of light from the lighting assembly 100. For example, the tube 102 may be able to emit light from a very cool light color to a very warm color, and the adjuster allows a user to determine the desired light color temperatures between the cool and warm color temperatures.

Some implementations of the lighting apparatus 100 include one or more sensors, for example, to improve the performance, energy savings, or life expectancy of the device. Sensors may include one or more of the following: a photo sensor; a motion sensor; a thermal sensor; a remote control sensor; and the like.

According to one embodiment, the light tube 102 may have a photo sensor for adjusting to a light level of an area outside the tube 102. The photo sensor may be integral with the tube 102, and it may be located within the tube 102. In another embodiment, the light tube 102 may have a color adjusting potentiometer, for adjusting the color temperature of the light output from the lighting assembly 100. This can be achieved, for example, by adjusting voltages to LEDs of different color temperatures to result in a variety of color temperatures.

According to another embodiment, the lighting assembly 100 may have a motion sensor or a temperature sensor. The motion sensor may sense motion outside the tube and activate the light accordingly. A temperature sensor may sense a temperature within the tube and adjust light output to reduce power consumption if the lighting assembly 100 gets too hot. The lighting assembly 100 may also have a remote receiver, allowing a user to adjust power, light, or a color temperature of the lighting assembly 100 from a remote location.

The photosensor may sense the amount of natural light in the environment and adjust the output accordingly, which can help save energy. For example, if there is a lot of natural bright light in a room, the photosensor may dim or turn off the bulbs.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A lighting assembly, comprising:
a tube, at least a portion of the tube being translucent;
a light emitting diode panel disposed within the tube, the light emitting diode panel comprising a plurality of light emitting diodes;
a circuit board disposed within the tube, the circuit board including a driving circuit for driving the plurality of light emitting diodes of the light emitting diode panel; and
insulation disposed between the light emitting diode panel and the circuit board.

2. The lighting assembly of claim 1 further comprising:
a first end cap disposed on a first end of the tube; and
a second end cap disposed on a second end of the tube.

3. The lighting assembly of claim 2, wherein the first end cap includes two conductors electrically connected to the driving circuit.

4. The lighting assembly of claim 3, wherein the two conductors of the first end cap are electrically connected to the driving circuit by power leads.

5. The lighting assembly of claim 3, wherein the driving circuit is electrically isolated from the second end cap.

6. The lighting assembly of claim 2, wherein the driving circuit is electrically connected to a single end cap from the group consisting of: the first end cap and the second end cap.

7. The lighting assembly of claim 1, wherein the tube includes a reflective coating disposed on a portion of the tube.

8. The lighting assembly of claim 1, further comprising a thermal sensor.

9. The lighting assembly of claim 8, wherein the driving circuit provides a thermal control function using the thermal sensor.

10. The lighting assembly of claim 9, wherein the driving circuit is configured to reduce the brightness of at least some of the plurality of light emitting diodes when a temperature measured using the thermal sensor is greater than a predetermined value.

11. The lighting assembly of claim 10, wherein the predetermine value is selected so as to extend the lifetime of at least some of the plurality of light emitting diodes.

12. The lighting assembly of claim 1, further comprising a motion sensor.

13. The lighting assembly of claim 12, wherein the driver circuit is configured to enter an active state upon detection of motion using the motion sensor.

14. The lighting assembly of claim 13, wherein the driver circuit is further configured to enter an inactive state after a predetermined period of time after detection of motion using the motion sensor.

15. The lighting assembly of claim 14, wherein the driver circuit reduces the brightness of at least some of the plurality of light emitting diodes in the inactive state.

16. The lighting assembly of claim 14, wherein the driver circuit turns off at least some of the plurality of light emitting diodes in the inactive state.

17. The lighting assembly of claim 1, further comprising a remote control sensor.

18. The lighting assembly of claim 17, wherein the driver circuit, in response to a signal received using the remote control sensor, is operable to perform one or more functions from the group consisting of: disable at least one of the plurality of light emitting diodes; and change the brightness of at least one of the plurality of light emitting diodes.

19. The lighting assembly of claim 1 further comprising a photosensor.

20. The lighting assembly of claim 19, wherein the driver circuit, in response to a signal received using the photosensor, is operable to perform one or more functions from the group consisting of: disable at least one of the plurality of light emitting diodes; and change the brightness of at least one of the plurality of light emitting diodes.

21. The lighting assembly of claim 1, wherein the plurality of light emitting diodes includes a first set of light emitting diodes having a first color temperature and a second set of light emitting diodes having a second color temperature.

22. The lighting assembly of claim 21, wherein the first color temperature is approximately 3300 Kelvin and the second color temperature is approximately 5800 Kelvin.

23. The lighting assembly of claim 21, wherein the driver circuit is operable to vary the color temperature of the light emitting diode panel by controlling the brightness of the first set of light emitting diodes relative to the brightness of the second set of light emitting diodes.

24. The lighting assembly of claim 23 further comprising a photosensor, wherein the driver circuit is operable to vary the color temperature of the light emitting diode panel in response to a signal received from the photosensor.

25. The lighting assembly of claim 1, wherein at least a portion of the tube comprises metal.

26. The lighting assembly of claim 1, further comprising a heat sink.

27. The lighting assembly of claim 26, wherein the heat sink is attached to the tube.

28. The lighting assembly of claim 1, wherein the light emitting diode panel includes one or more curved surfaces.

29. The lighting assembly of claim 1, further comprising a second light emitting diode panel, the light emitting diode panel and the second light emitting diode panel primarily emitting light in different directions.

30. The lighting assembly of claim 1, further comprising one or more reflectors.

31. The lighting assembly of claim 1, wherein the lighting assembly is configured to be received by a fluorescent light socket.

32. The lighting assembly of claim 2, wherein the lighting assembly includes an active end cap and an inactive end cap, the active end cap being electrically connected to the driver circuit, and the inactive end cap being electrically isolated from the driver circuit, and wherein the inactive end cap includes a protrusion so as to prevent improper installation of the lighting assembly.

33. The lighting assembly of claim 1, wherein the plurality of light emitting diodes include at least one light emitting diode that emits light of a first color temperature, and at least one light emitting diode that emits light of a second color temperature.

34. The lighting assembly of claim 31, wherein the lighting assembly is configured to be received by one of the group consisting of: size T4; size T5; size T8; size T10; size T12; size T14.

35. A method for configuring a fluorescent light fixture for use with a replacement lighting assembly using light emitting diodes, the method comprising:
removing a ballast from a fluorescent light fixture; and
removing an external driver from the fluorescent light fixture.

36. The method of claim 35, further comprising rewiring the fluorescent light fixture to power the replacement lighting assembly using light emitting diodes.

37. The method of claim 36, wherein rewiring the fluorescent light fixture to power the replacement lighting assembly using light emitting diodes includes wiring a positive voltage line to a first pin of lamp pin base and wiring a negative voltage line to a second pin of the lamp pin base.

38. The method of claim 37, wherein rewiring the fluorescent light fixture to power the replacement lighting assembly using light emitting diodes includes disconnecting power from a lamp pin base.
